(19) United States
(12) Patent Application Publication
(10) Pub. No.: US 2025/0147305 A1
(43) Pub. Date: May 8, 2025

(54) OPTICAL IMAGING DEVICE AND ELECTRONIC DEVICE FOR CORRECTING CHROMATIC ABERRATION

(71) Applicant: SAMSUNG ELECTRONICS CO., LTD., Suwon-si (KR)

(72) Inventors: Anton SOFRONOV, Suwon-si (KR); Se Yoon KIM, Suwon-si (KR); Won Teak SEO, Suwon-si (KR); Jang Woo YOU, Suwon-si (KR); Du Hyun LEE, Suwon-si (KR)

(73) Assignee: SAMSUNG ELECTRONICS CO., LTD., Suwon-si (KR)

(21) Appl. No.: 18/606,999

(22) Filed: Mar. 15, 2024

(30) Foreign Application Priority Data
Nov. 2, 2023 (KR) 10-2023-0150164

(51) Int. Cl. G02B 27/00; B82Y 20/00; G02B 1/00; G02B 1/02; G02B 13/00

(52) U.S. Cl. CPC G02B 27/0037; B82Y 20/00; G02B 1/002; G02B 1/02; G02B 13/008; G02B 2207/101

(57) ABSTRACT

An optical imaging device includes: an optical lens; and a spaceplate configured to transmit light that has passed through the optical lens, wherein the spaceplate may include a plurality of layers configured to correct a chromatic aberration of the optical lens.

### CROSS-REFERENCE TO RELATED APPLICATION(S)

This application claims priority to Korean Patent Application No. 10-2023-0150164, filed on Nov. 2, 2023, in the Korean Intellectual Property Office, the entire disclosure of which is incorporated by reference herein for all purposes.

### BACKGROUND

### 1. Field

The following description relates to an optical imaging device, a camera module, and an electronic device for correcting chromatic aberration.

### 2. Description of Related Art

For image sensing, an optical imaging device requires an optical lens capable of controlling light wavefronts or light propagation paths.

If light incident on the optical imaging device has different wavelengths, chromatic aberration may occur in which a focal length of the optical lens varies with wavelength, which limits the spectral range for wideband operation of the optical imaging device.

Generally, a plurality of lenses are used in a bulk optical device in order to correct chromatic aberration, but there are drawbacks in that the optical device increases in size due to the volume of the lenses, the manufacturing process becomes complicated, and is not compatible with expandable very large scale integration (VLSI) technology, thereby making it expensive to manufacture.

In an optical device of a diffractive optical element using the metalens, chromatic aberration is corrected using a bifocal and trifocal metalens, but the use of bifocal and trifocal metalens has a drawback in that it is difficult to implement high-performance optical devices having a large numerical aperture (NA).

### SUMMARY

According to an aspect of an example embodiment, an optical imaging device includes: an optical lens; and a spaceplate configured to transmit light that has passed through the optical lens, wherein the spaceplate may include a plurality of layers configured to correct a chromatic aberration of the optical lens.

The optical lens may include a metalens.

The metalens may be configured to operate in a long-wave infrared (LWIR) spectral range.

The plurality of layers may include at least three layers that are stacked on each other.

A first thickness of a first layer of the at least three layers may be based on a first relationship between a predetermined resonant wavelength and a first refractive index of the first layer, a second thickness of a second layer of the at least three layers may be based on a second relationship between the predetermined resonant wavelength and a second refractive index of the second layer, and a third thickness of a third layer of the at least three layers may be based on a third relationship between the predetermined resonant wavelength and a third refractive index of the third layer.

The first thickness may be equal to the predetermined resonant wavelength divided by a first quantity, the first quantity being four times the first refractive index, the second thickness may be equal to the predetermined resonant wavelength divided by a second quantity, the second quantity being two times the second refractive index, and the third thickness may be equal to the predetermined resonant wavelength divided by a third quantity, the third quantity being four times the third refractive index.

The first refractive index and the third refractive index may be equal to each other.

The first refractive index may be greater than the second refractive index.

Each of the at least three layers may be a dielectric layer.

Each of a first layer and a third layer of the at least three layers may include at least one of zinc sulfide (ZnS) and zinc selenide (ZnSe), and a second layer of the at least three layers may include at least one of calcium fluoride (CaF2) and barium fluoride (BaF2).

The optical lens may be configured to operate in a short-wave infrared (SWIR) spectral range, each of a first layer and a third layer of the at least three layers may include of silicon nitride (SiN), and a second layer of the at least three layers may include of silicon dioxide (SiO₂).

The optical lens and the spaceplate may contact each other.

According to an aspect of an example embodiment, a camera module includes: a metalens; an image sensor configured to convert light, that is emitted or reflected from an object and transmitted through the metalens, into an electrical signal; and a spaceplate between the metalens and the image sensor, and configured to transmit light that has passed through the metalens, wherein the spaceplate may include a plurality of layers configured to correct a chromatic aberration of the metalens.

The spaceplate may include a first layer, a second layer, and a third layer that are stacked on each other.

A first thickness of the first layer may be based on a first relationship between a predetermined resonant wavelength and a first refractive index of the first layer, a second thickness of the second layer may be based on a second relationship between the predetermined resonant wavelength and a second refractive index of the second layer, and a third thickness of the third layer may be based on a third relationship between the predetermined resonant wavelength and a third refractive index of the third layer.

Each of the first layer and the third layer may include at least one of zinc sulfide (ZnS) and zinc selenide (ZnSe), and the second layer may include at least one of calcium fluoride (CaF2) and barium fluoride (BaF2).

The metalens and the spaceplate may contact each other.

According to an aspect of an example embodiment, electronic device includes: a camera module including: a metalens; an image sensor configured to convert light, that is emitted or reflected from an object and transmitted through the metalens, into an electrical signal to generate image data; and a spaceplate between the metalens and the image sensor, and configured to transmit light that has passed through the metalens; and a processor configured to perform one or more image processing operations on the generated image data, wherein the spaceplate may include a plurality of layers configured to correct chromatic aberration of the metalens.

The spaceplate may include a stack of at least three layers.

The plurality of layers may include a first layer, and second layer, and a third layer, the second layer is between the first layer and the second layer, each of the first layer and the third layer may include at least one of zinc sulfide (ZnS) and zinc selenide (ZnSe), and the second layer may include at least one of calcium fluoride (CaF2) and barium fluoride (BaF2).

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an optical imaging device for correcting chromatic aberration according to an embodiment of the present disclosure;

FIG. 2 is a diagram schematically illustrating a spaceplate according to an embodiment of the present disclosure;

FIG. 3A and FIG. 3B are diagrams explaining spatial squeezing and spatial expanding using a spaceplate in an optical imaging device according to an embodiment of the present disclosure;

FIG. 4 is a diagram schematically illustrating the arrangement of an optical lens and a spaceplate in an optical imaging device according to an embodiment of the present disclosure;

FIG. 5 is a graph of a focal length with respect to wavelength in the case of using both a metalens and a spaceplate in an optical imaging device according to an embodiment of the present disclosure and in the case of using only the metalens in the optical imaging device;

FIG. 6 is a block diagram illustrating a camera module including a spaceplate according to an embodiment of the present disclosure; and

FIG. 7 is a block diagram illustrating an electronic device including a camera module according to an embodiment of the present disclosure.

### DETAILED DESCRIPTION

Details of example embodiments are provided in the following detailed description and drawings. Advantages and features of the present disclosure, and methods of achieving the same will be more clearly understood from the following embodiments described in detail with reference to the accompanying drawings. Throughout the drawings and the detailed description, unless otherwise described, the same drawing reference numerals will be understood to refer to the same elements, features, and structures.

It will be understood that, although the terms, “first,” “second,” etc., may be used herein to describe various elements, these elements should not be limited by these terms. These terms are only used to distinguish one element from another. Any references to singular may include plural unless expressly stated otherwise. In addition, unless explicitly described to the contrary, an expression such as “comprising” or “including” will be understood to imply the inclusion of stated elements but not the exclusion of any other elements. Also, the terms, such as “unit” or “module,” etc., should be understood as a unit that performs at least one function or operation and that may be embodied as hardware, software, or a combination thereof.

In addition, the expression, such as “at least one of,” for example, “at least one of a, b, and c,” should be understood as including only a, only b, only c, both a and b, both a and c, both b and c, or all of a, b, and c.

Optical imaging devices are devices for generating or manipulating images by using light, and these devices work based on the principles of optics to control the propagation, transmission, and detection of light. A typical optical imaging device essentially includes an optical lens, and the optical lens itself may also be called the optical imaging device.

In the case of using multi-color light sources having a plurality of wavelengths as light sources of an optical imaging device, chromatic aberration occurs when an optical lens fails to focus different colors of light to the same point such that light having passed through the optical lens is dispersed by refraction that changes with wavelength. An image formed using multi-color light sources may appear unclear and distorted due to chromatic aberration.

As described above, a metalens formed by combining a plurality of optical lenses or layers is generally used to correct the chromatic aberration, but the effect of correcting chromatic aberration is limited depending on design, performance, or cost of the lens.

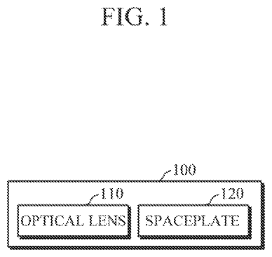

FIG. 1 is a block diagram illustrating an optical imaging device 100 for correcting chromatic aberration according to one or more embodiments of the present disclosure.

Referring to FIG. 1, an optical imaging device 100 includes an optical lens 110 and a spaceplate 120.

The optical lens 110 is an optical element for focusing or dispersing light and may be made of materials, such as glass, plastic, metal, etc., and a combination of one or more lenses may be used for correcting various aberrations, such as chromatic aberration and the like.

The optical lens 110 may include a metalens. The metalens is a diffractive optical element and has, as a basic structure, dielectrics called metaatoms having a size ranging from hundreds of nanometers (nm) to several micrometers (μm). The metalens has a metasurface with metaatoms arranged in a two-dimensional plane. In this case, the metalens may operate in a long-wave infrared (LWIR) spectral range (e.g., 8 μm to 14 μm). However, the operating wavelength range of the metalens is not limited thereto.

The spaceplate 120 refers to a planar optical element for spatial squeezing or expanding in the phase of light that propagates therein.

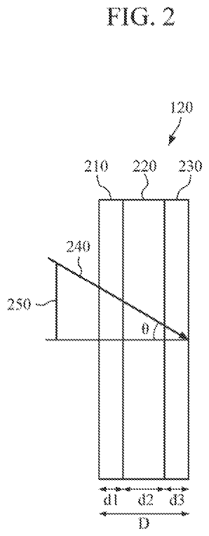

FIG. 2 is a diagram schematically illustrating the spaceplate 120 according to one or more embodiments of the present disclosure.

Referring to FIG. 2, the phase of light passing through the spaceplate 120 may be represented by the following Equation 1:

$$\begin{matrix}Equation l & \\ φ ( θ ) ≅ {φ}_{0} - \frac{{L}_{eff}}{2 k} {k}_{t}^{2} , & Eq . 1\end{matrix}$$

where θ denotes an angle of incidence, φ(θ) denotes a phase, φ₀ denotes an initial phase, K (corresponding to component 240 in FIG. 2) and Kt (corresponding to component 250 in FIG. 2) denote components of a wave vector, and L_{eff} denotes an effective optical path length.

In Equation 1, the phase of light transmitted to the spaceplate 120 depends on the effective optical path length L_{eff} which is the effective optical path length of light passing through the spaceplate 120, and the effective optical path length L_{eff} may be greater or smaller than a physical thickness (e.g., thickness D of FIG. 2) of the spaceplate 120. In this case, the thickness D may be between several tens of nanometers (nm) and several micrometers (μm).

If the effective optical path length L_{eff} is greater than the thickness D, spatial squeezing may be performed by selecting a resonant wavelength and a refractive index of a material of the spaceplate 120 so that the spaceplate 120 and a free-space layer may have the same phase, and if the effective optical path length L_{eff} is smaller than the thickness D, spatial expanding may be performed by selecting a resonant wavelength and a refractive index of a material of the spaceplate 120 so that the spaceplate 120 and a free-space layer may have the same phase. In this case, spatial squeezing and spatial expanding may indicate that the focal length of a lens for a predetermined wavelength becomes shorter or longer to be closer to or further away from the lens.

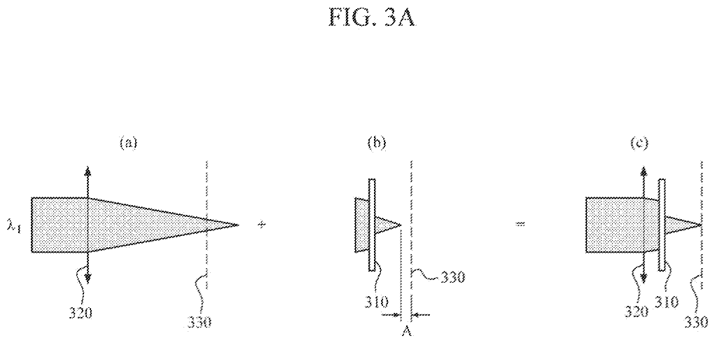

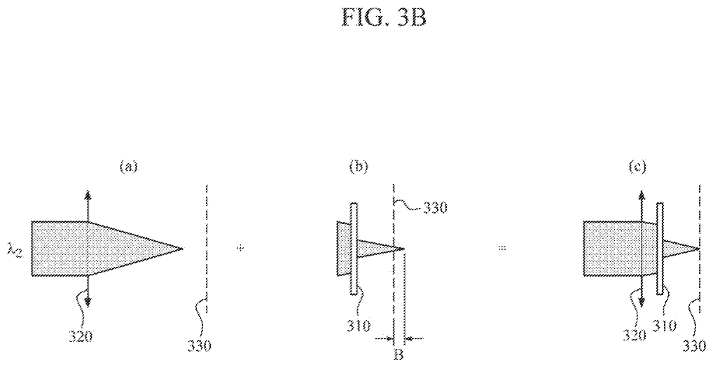

FIG. 3A and FIG. 3B are diagrams explaining spatial squeezing and spatial expanding using a spaceplate in an optical imaging device according to one or more embodiments of the present disclosure.

Referring to FIG. 3A, FIG. 3A (a) indicates the case where a focal length of light with a predetermined wavelength λ1, which passes through an optical lens 320, is longer than a target focal length 330, FIG. 3A (b) indicates the case where a focal length of light with the predetermined wavelength, which passes through the spaceplate 310, is shorter than the target focal length 330, and FIG. 3A (c) indicates the case where FIG. 3A (a) and FIG. 3A (b) are combined, in which by using both the optical lens 320 and the spaceplate 310, a focal length of the light with the predetermined wavelength coincides with the target focal length 330. That is, if a focal length of the optical lens 320 is longer than the target focal length 330, space squeezing is performed using the spaceplate 310 so that the focal length becomes shorter than the target focal length 330, and thus the target focal length 330 may be formed as a final focal length. In this case, a length of the squeezed space corresponds to length A.

Referring to FIG. 3B, FIG. 3B (a) indicates the case where a focal length of light with a predetermined wavelength 22, which passes through an optical lens 320, is shorter than the target focal length 330, FIG. 3B (b) indicates the case where a focal length of light with the predetermined wavelength, which passes through the spaceplate 310, is longer than the target focal length 330, and FIG. 3B (c) indicates the case where FIG. 3B (a) and FIG. 3B (b) are combined, in which by using both the optical lens 320 and the spaceplate 310, a focal length of the light with the predetermined wavelength coincides with the target focal length 330. That is, if a focal length of the optical lens 320 is shorter than the target focal length 330, space expanding is performed using the spaceplate 310 so that the focal length becomes longer than the target focal length 330, and thus the target focal length 330 may be formed as a final focal length. In this case, a length of the expanded space corresponds to length B.

By spatial expanding or spatial squeezing using the spaceplate 310, the optical imaging device, alone or in combination with an optical lens, may obtain a desired focal length for a predetermined wavelength, thereby correcting chromatic aberration in which the focal length varies with wavelength.

The spaceplate, through which light having passed through the optical lens is transmitted to correct chromatic aberration of the optical lens, may have a plurality of layers. For example, the spaceplate 120 may be formed by stacking three or more layers.

Referring back to FIG. 2, the spaceplate 120 may be formed, for example, by stacking a first layer 210, a second layer 220, and a third layer 230, in which the first layer 210 is formed with a first refractive index n₁ and a first thickness d₁, the second layer 220 is formed with a second refractive index n₂ and a second thickness d₂, and the third layer 230 is formed with a third refractive index n₃ and a third thickness d₃.

In this case, the thickness of each layer may be determined based on a relationship between a predetermined resonant wavelength and the refractive index of each layer, and may be represented by the following Equation 2, Equation 3, and Equation 4.

$$\begin{matrix}Equation 2 & \\ {d}_{1} = \frac{{λ}_{r}}{4 {n}_{1}} & Eq . 2\end{matrix}$$

$$\begin{matrix}Equation 3 & \\ {d}_{2} = \frac{{λ}_{r}}{2 {n}_{2}} & Eq . 3\end{matrix}$$

$$\begin{matrix}Equation 4 & \\ {d}_{3} = \frac{{λ}_{r}}{4 {n}_{3}} & Eq . 4\end{matrix}$$

According to the above Equation 2, Equation 3, and Equation 4, the first thickness d₁ may be obtained by, for example, dividing a predetermined resonant wavelength λ in a long-wave spectral range by the first refractive index n₁ multiplied by four, and the second thickness d₂ may be obtained by dividing the predetermined resonant wavelength λ by the second refractive index n₂ multiplied by two, and the third thickness d₃ may be obtained by dividing the predetermined resonant wavelength λ by the third refractive index n₃ multiplied by four. In this case, the first refractive index n₁ and the third refractive index n₃ may be the same value, and the first refractive index n₁ may be a value greater than the second refractive index n₂. The relationship between the refractive indices of the respective layers is not limited thereto.

The plurality of layers of the spaceplate 120 may have a resonant structure, and may have, for example, a resonant structure such as a fabry-perot interferometer.

The spaceplate 120 may be a uniaxial or biaxial optical crystal material with spatial dispersion, and each layer may be formed as a dielectric layer. For example, if an optical lens operates in the LWIR spectral range, the first layer 210 and the third layer 230 may be made of at least one of zinc sulfide (ZnS) and zinc selenide (ZnSe), and the second layer 220 may be made of at least one of calcium fluoride (CaF₂) and barium fluoride (BaF₂). If the optical lens operates in a short-wave infrared (SWIR) spectral range (e.g., 5 μm or less), the first layer 210 and the third layer 230 may be made of silicon nitride (SiN), and the second layer 220 may be made of silicon dioxide (SiO₂). The dielectric layer formed for each layer is not limited thereto.

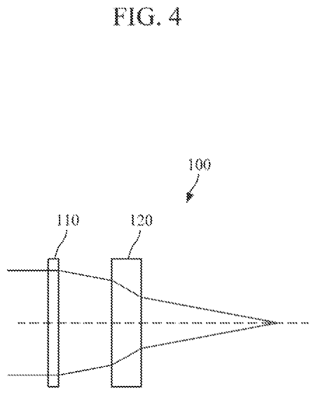

FIG. 4 is a diagram schematically illustrating the arrangement of an optical lens and a spaceplate in an optical imaging device according to one or more embodiments of the present disclosure.

Referring to FIG. 4, the spaceplate 120 may be located behind the optical lens 110 relative to the direction of light propagation. The optical lens 110 and the spaceplate 120 may be spaced apart from each other by a predetermined distance, and the spaceplate 120 may be formed in direct contact with the lens by, for example, depositing a layer on a rear surface of a metal lens.

The focal length of the metalens increases as the wavelength of the received light decreases, but in contrast, by setting a refractive index of the spaceplate so that the focal length decreases as the wavelength decreases, chromatic aberration may be easily corrected.

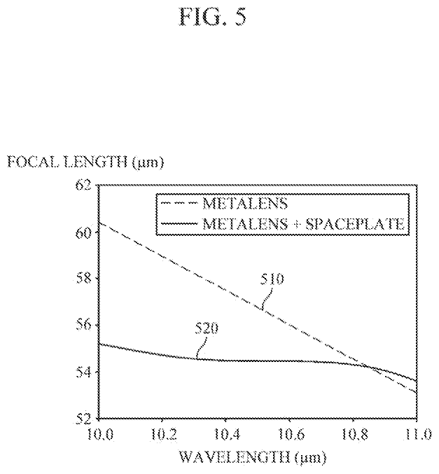

FIG. 5 is a graph of a focal length with respect to wavelength in the case of using both a metalens and a spaceplate in an optical imaging device according to one or more embodiments of the present disclosure and in the case of using only the metalens in the optical imaging device.

Referring to FIG. 5, in the case of using both the metalens and the spaceplate, a focal length 520 of the optical imaging device remains constant in a range of 54 μm to 56 μm, but in the case of using only the metalens, a focal length 510 of the optical imaging device changes relatively significantly with wavelength. In this embodiment, it can be seen that chromatic aberration may be corrected effectively by using both the metalens and the spaceplate.

Generally, the optical imaging device uses a plurality of lenses to correct chromatic aberration caused by multi-color light sources, such that the volume of the lenses increases due to a complex lens design, thereby increasing the overall volume. According to this embodiment, by placing the spaceplate with a size of about several tens of nanometers behind the optical lens, chromatic aberration may be easily corrected, and the volume of the optical imaging device may also be reduced.

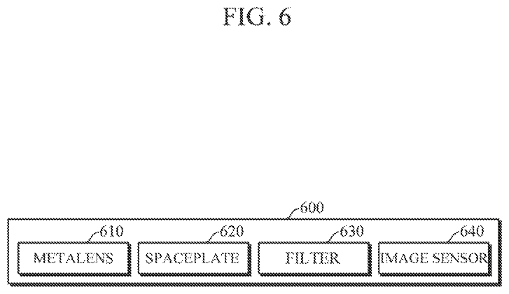

FIG. 6 is a block diagram illustrating a camera module 600 including a spaceplate 620 according to one or more embodiments of the present disclosure.

Referring to FIG. 6, a camera module 600 includes a metalens 610, a spaceplate 620, a filter 630, and an image sensor 640.

The metalens 610 is a type of diffractive optical element and may have a metasurface composed of a plurality of metaatoms.

The image sensor 640 may convert an image, formed by the metalens 610, into an electrical signal. The image sensor 640 may convert light, emitted or reflected from an object and transmitted through the metalens 610, into an electrical signal to acquire an image corresponding to the object. The image sensor 640 may include at least one of an RGB sensor, a black and white (BW) sensor, an infrared (IR) sensor, and an ultraviolet (UV) sensor, but is not limited thereto. In addition, each sensor included in the image sensor 640 may be implemented as a charged coupled device (CCD) sensor and/or a complementary metal oxide semiconductor (CMOS) sensor.

The filter 630 is disposed between the metalens 610 and the image sensor 640, and for example, an IR filter may be disposed to remove an IR component included in the image.

The spaceplate 620 is a planar optical element for spatial squeezing or expanding in the phase of light that propagates therein, and is disposed between the metalens 610 and the image sensor 640. Light having passed through the metalens 610 is transmitted through the spaceplate 620, and the spaceplate 620 may have a plurality of layers to correct chromatic aberration of the metalens.

For example, the spaceplate 620 may be formed by stacking a first layer 210, a second layer 220, and a third layer 230, in which the first layer 210 and the third layer 230 may be made of at least one of zinc sulfide (ZnS) and zinc selenide (ZnSe), and the second layer 220 may be made of at least one of calcium fluoride (CaF₂) and barium Fluoride (BaF₂). In this case, the thickness of each layer may be determined based on a relationship between a predetermined resonant wavelength and the refractive index of each layer. The metalens 610 and the spaceplate 620 may be spaced apart from each other by a predetermined distance and may also be formed in contact with each other.

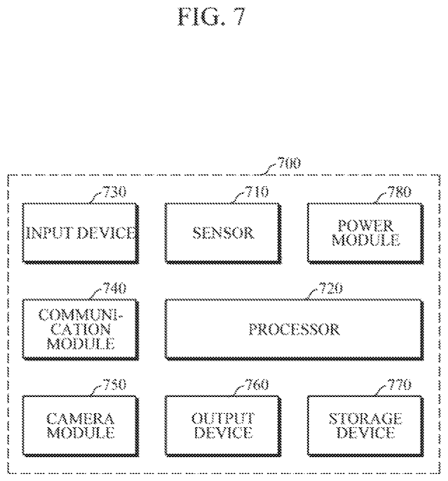

FIG. 7 is a block diagram illustrating an electronic device including a camera module according to one or more embodiments of the present disclosure.

An electronic device which will be described below may include, for example, at least one of a wearable device, a smartphone, a tablet PC, a mobile phone, a video phone, an electronic book reader, a desktop computer, a laptop computer, a netbook computer, a workstation, a server, a personal digital assistant (PDA), a portable multimedia player (PMP), an MP3 player, a medical device, and a camera. The wearable device may include at least one of an accessory type wearable device (e.g., wristwatch, ring, bracelet, anklet, necklace, glasses, contact lens, or head mounted device (HMD)), a textile/clothing type wearable device (e.g., electronic clothing), a body-mounted type wearable device (e.g., skin pad or tattoo), and a body implantable type wearable device. However, the wearable device is not limited thereto and may include, for example, various types of medical equipment including various portable medical measuring devices (antioxidant measuring device, blood glucose monitor, heart rate monitor, blood pressure measuring device, thermometer, etc.), magnetic resonance angiography (MRA), magnetic resonance imaging (MRI), computed tomography (CT), imaging system, ultrasonic system, etc.) and the like. However, the electronic device is not limited to the above devices.

Referring to FIG. 7, an electronic device 700 includes a sensor 710, a processor 720, an input device 730, a communication module 740, a camera module 750, an output device 760, a storage device 770, and a power module 780. The components of the electronic device 700 may be integrally mounted in a specific device, or may be distributed in two or more devices.

The sensor 710 may detect an operating state (e.g., temperature, power, etc.) of the electronic device 700 or an external environmental condition (e.g., user state), etc., and may generate an electrical signal and/or data corresponding to the detected state. The sensor 710 may include a gyro sensor, a pulse wave sensor, an acceleration sensor, a fingerprint sensor, etc., but is not limited thereto.

The processor 720 may control components connected to the processor 720 by executing programs and the like stored in the storage device 770, and may perform processing of various data or perform operations. The processor 720 may be a single processor or a plurality of processors. The one or more processors 720 may include a main processor, e.g., a central processing unit (CPU) or an application processor (AP), etc., and an auxiliary processor, e.g., a graphics processing unit (GPU), an image signal processor (ISP), a sensor hub processor, and/or a communication processor (CP), which is operable independently from, or in conjunction with, the main processor, and the like.

The input device 730 may receive instructions and/or data for use in the respective components of the electronic device 700 from a user and the like. The input device 730 may include a microphone, a mouse, a keyboard, and/or a digital pen (e.g., a stylus pen, etc.), and the like.

The communication module 740 may support establishment of a direct (e.g., wired) communication channel and/or a wireless communication channel between the electronic device 700 and other electronic device, a server, or the sensor 710 within a network environment, and performing of communication via the established communication channel. The communication module 740 may include one or more communication processors that operate independently to the processor 720 and support direct communication and/or wireless communication.

The communication module 740 may include a wireless communication module, such as a cellular communication module, a short-range wireless communication module, a Global Navigation Satellite System (GNSS) communication module, etc., and/or a wired communication module, such as a local area network (LAN) communication module, a power line communication module, and the like. These various types of communication modules may be integrated into a single chip and the like, or may be implemented as a plurality of separate chips. The wireless communication module may identify and authenticate the electronic device 700 in a communication network by using subscriber information (e.g., international mobile subscriber identifier (IMSI), etc.,) stored in a subscriber identification module.

The camera module 750 may capture still images or moving images. The camera module 750 may include a lens assembly having one or more lenses, image sensors, image signal processors, IR filter, and/or flashes. The lens assembly included in the camera module 750 may collect light emitted from an object to be imaged.

For example, the camera module 750 may include a metalens, an image sensor configured to convert light, emitted or reflected from an object and transmitted through the metalens, into an electrical signal to generate image data, and a spaceplate disposed between the metalens and the image sensor. In this case, light having passed through the metalens is transmitted through the spaceplate, and the spaceplate may have a plurality of layers to correct chromatic aberration of the metalens. In the case where the spaceplate is formed with three layers, two layers disposed on both sides thereof may be made of at least one of zinc sulfide (ZnS) and zinc selenide (ZnSe), and the layer disposed in the middle may be made of at least one of calcium fluoride (CaF₂) and barium fluoride (BaF₂).

The processor 720 may include a processor of the aforementioned camera module 750, and may perform one or more image processing operations on the image data generated by the camera module 750.

The output device 760 may visually/non-visually output the data generated or processed by the electronic device 700. The output device 760 may include a sound output device, a display device, an audio module, and/or a haptic module.

The sound output device may output sound signals to the outside of the electronic device 700. The sound output device may include a speaker and/or a receiver. The speaker may be used for general purposes, such as playing multimedia or playing record, and the receiver may be used for incoming calls. The receiver may be implemented separately from, or as part of, the speaker.

The display device may visually provide information to the outside of the electronic device 700. The display device may include, for example, a display, a hologram device, or a projector and control circuitry to control the devices. The display device may include touch circuitry adapted to detect a touch, and/or sensor circuitry (e.g., pressure sensor, etc.) adapted to measure the intensity of force incurred by the touch.

The audio module may convert a sound into an electrical signal or vice versa. The audio module may obtain the sound via the input device, or may output the sound via the sound output device, and/or a speaker and/or a headphone of another electronic device directly or wirelessly connected to the electronic device 700.

The haptic module may convert an electrical signal into a mechanical stimulus (e.g., vibration, motion, etc.) or electrical stimulus which may be recognized by a user by tactile sensation or kinesthetic sensation. The haptic module may include, for example, a motor, a piezoelectric element, and/or an electric stimulator.

The storage device 770 may store operating conditions required for operating the sensor 710, and various data required for other components of the electronic device 700. The various data may include, for example, input data and/or output data for software and instructions related thereto. The storage device 770 may include a volatile memory and/or a non-volatile memory.

The power module 780 may manage power supplied to the electronic device 700. The power module may be implemented as part of, for example, a power management integrated circuit (PMIC). The power module 780 may include a battery, which may include a primary cell which is not rechargeable, a secondary cell which is rechargeable, and/or a fuel cell.

The present disclosure can be realized as a computer-readable code written on a computer-readable recording medium. The computer-readable recording medium may be any type of recording device in which data is stored in a computer-readable manner.

Examples of the computer-readable recording medium include a read-only memory (ROM), a random access memory (RAM), a compact disc (CD)-ROM, a magnetic tape, a floppy disc, an optical data storage, and a carrier wave (e.g., data transmission through the Internet). The computer-readable recording medium can be distributed over a plurality of computer systems connected to a network so that a computer-readable code is written thereto and executed therefrom in a decentralized manner. Functional programs, codes, and code segments needed for realizing the present disclosure can be readily inferred by programmers of ordinary skill in the art to which the disclosure pertains.

The present disclosure has been described herein with regard to example embodiments. However, it will be understood by those skilled in the art that various changes and modifications can be made without changing technical conception and essential features of the present disclosure. Thus, it is clear that the above-described embodiments are illustrative in all aspects and are not intended to limit the present disclosure.

What is claimed is:

1. An optical imaging device comprising:
an optical lens; and
a spaceplate configured to transmit light that has passed through the optical lens,
wherein the spaceplate comprises a plurality of layers configured to correct a chromatic aberration of the optical lens.

2. The optical imaging device of claim 1, wherein the optical lens comprises a metalens.

3. The optical imaging device of claim 2, wherein the metalens is configured to operate in a long-wave infrared (LWIR) spectral range.

4. The optical imaging device of claim 1, wherein the plurality of layers comprises at least three layers that are stacked on each other.

5. The optical imaging device of claim 4, wherein a first thickness of a first layer of the at least three layers is based on a first relationship between a predetermined resonant wavelength and a first refractive index of the first layer,
wherein a second thickness of a second layer of the at least three layers is based on a second relationship between the predetermined resonant wavelength and a second refractive index of the second layer, and
wherein a third thickness of a third layer of the at least three layers is based on a third relationship between the predetermined resonant wavelength and a third refractive index of the third layer.

6. The optical imaging device of claim 5, wherein the first thickness is equal to the predetermined resonant wavelength divided by a first quantity, the first quantity being four times the first refractive index,
wherein the second thickness is equal to the predetermined resonant wavelength divided by a second quantity, the second quantity being two times the second refractive index, and
wherein the third thickness is equal to the predetermined resonant wavelength divided by a third quantity, the third quantity being four times the third refractive index.

7. The optical imaging device of claim 6, wherein the first refractive index and the third refractive index are equal to each other.

8. The optical imaging device of claim 7, wherein the first refractive index is greater than the second refractive index.

9. The optical imaging device of claim 4, wherein each of the at least three layers is a dielectric layer.

10. The optical imaging device of claim 9, wherein each of a first layer and a third layer of the at least three layers comprises at least one of zinc sulfide (ZnS) and zinc selenide (ZnSe), and
wherein a second layer of the at least three layers comprises at least one of calcium fluoride (CaF₂) and barium fluoride (BaF₂).

11. The optical imaging device of claim 9, wherein the optical lens is configured to operate in a short-wave infrared (SWIR) spectral range,
wherein each of a first layer and a third layer of the at least three layers comprises of silicon nitride (SiN), and
wherein a second layer of the at least three layers comprises of silicon dioxide (SiO₂).

12. The optical imaging device of claim 1, wherein the optical lens and the spaceplate contact each other.

13. A camera module comprising:
a metalens;
an image sensor configured to convert light, that is emitted or reflected from an object and transmitted through the metalens, into an electrical signal; and
a spaceplate between the metalens and the image sensor, and configured to transmit light that has passed through the metalens,
wherein the spaceplate comprises a plurality of layers configured to correct a chromatic aberration of the metalens.

14. The camera module of claim 13, wherein the spaceplate comprises a first layer, a second layer, and a third layer that are stacked on each other.

15. The camera module of claim 14, wherein a first thickness of the first layer is based on a first relationship between a predetermined resonant wavelength and a first refractive index of the first layer,
wherein a second thickness of the second layer is based on a second relationship between the predetermined resonant wavelength and a second refractive index of the second layer, and
wherein a third thickness of the third layer is based on a third relationship between the predetermined resonant wavelength and a third refractive index of the third layer.

16. The camera module of claim 14, wherein each of the first layer and the third layer comprises at least one of zinc sulfide (ZnS) and zinc selenide (ZnSe), and
wherein the second layer comprises at least one of calcium fluoride (CaF₂) and barium fluoride (BaF₂).

17. The camera module of claim 13, wherein the metalens and the spaceplate contact each other.

18. An electronic device comprising:
a camera module comprising:
a metalens;
an image sensor configured to convert light, that is emitted or reflected from an object and transmitted through the metalens, into an electrical signal to generate image data; and
a spaceplate between the metalens and the image sensor, and configured to transmit light that has passed through the metalens; and
a processor configured to perform one or more image processing operations on the generated image data,
wherein the spaceplate comprises a plurality of layers configured to correct chromatic aberration of the metalens.

19. The electronic device of claim 18, wherein the spaceplate comprises a stack of at least three layers.

20. The electronic device of claim 19, wherein the plurality of layers comprises a first layer, and second layer, and a third layer,
wherein the second layer is between the first layer and the second layer,
wherein each of the first layer and the third layer comprises at least one of zinc sulfide (ZnS) and zinc selenide (ZnSe), and
wherein the second layer comprises at least one of calcium fluoride (CaF₂) and barium fluoride (BaF₂).
